(19) United States
(12) Patent Application Publication
(10) Pub. No.: US 2019/0354065 A1
(43) Pub. Date: Nov. 21, 2019

(54) DEVELOPING DEVICE AND IMAGE FORMING APPARATUS INCLUDING THE SAME

(71) Applicant: SHARP KABUSHIKI KAISHA, Sakai City (JP)

(72) Inventor: JUN YAMAGUCHI, Sakai City (JP)

(21) Appl. No.: 16/399,141

(22) Filed: Apr. 30, 2019

(30) Foreign Application Priority Data
May 15, 2018 (JP) 2018-093715

(51) Int. Cl. G03G 21/18; G03G 21/16; G03G 21/00

(52) U.S. Cl. CPC G03G 21/1821; G03G 21/1647; G03G 2221/1654; G03G 2221/1853; G03G 21/0011

(57) ABSTRACT

An image forming apparatus includes a developing unit. The developing unit includes a developing mechanism, a photoconductor drum, a cleaner unit, a charging unit, and a development housing. The developing mechanism includes a developing roller. The development housing forms a developer tank that has an elongated substantially-box-shape extending in the front-back direction. The developer tank contains a developer, and a toner included in the developer is supplied to the photoconductor drum via the developing roller. The photoconductor drum, the cleaner unit, the charging unit, and a housing cover are each attachable to and detachable from the development housing.

### BACKGROUND

### 1. Field

The present disclosure relates to a developing device and an image forming apparatus including the developing device.

### 2. Description of the Related Art

Japanese Unexamined Patent Application Publication No. 2017-187738 discloses an example of an image forming apparatus according to the related art. The image forming apparatus according to the related art includes a photoconductor unit, which includes a photoconductive member as a latent image carrier on which a latent image is formed, and a developing unit, which includes a development sleeve as a developer carrier and which develops the latent image formed on the photoconductive member by using a developer.

In the image forming apparatus according to the related art, the developing unit is attachable to and detachable from the image forming apparatus independently from the photoconductor unit.

In recent years, due to need for improvement of image quality and the like, the distance (drum sleeve distance (DSD)) between a latent image carrier and a developer carrier has been decreasing, and need for increase in accuracy of DSD has been increasing.

However, with the image forming apparatus according to the related art, improvement of the accuracy of DSD is limited, because the photoconductive member, which is a latent image carrier, and the development sleeve, which is a developer carrier, are respectively held by holding members that are included in different units.

Accordingly, it is necessary to ensure the accuracy of DSD by providing a mechanism for pressing the developing roller against the photoconductive member, or to perform an adjustment operation for ensuring the accuracy of DSD when attaching the developing unit and the photoconductor unit to the image forming apparatus during, for example, assembly of the image forming apparatus or maintenance of the developing unit or the photoconductor unit.

Therefore, it is desirable to provide a novel developing device and an image forming apparatus including the developing device.

It is also desirable to provide a developing device that can increase the accuracy of the distance between a latent image carrier and a developer carrier and an image forming apparatus including the developing device.

### SUMMARY

According to a first aspect of the disclosure, there is provided a developing device including a housing, a latent image carrier, a developer carrier, a latent-image-carrier holding portion, and a developer-carrier holding portion. The housing forms a developer tank that contains a developer. The latent image carrier has a surface on which a latent image is to be formed. The developer carrier is accommodated in the developer tank and carries the developer that is used to develop the latent image formed on the latent image carrier. The latent-image-carrier holding portion is disposed in the housing and holds the latent image carrier at a predetermined position. The developer-carrier holding portion is disposed in the housing and holds the developer carrier at a predetermined position.

According to a second aspect of the disclosure, there is provided an image forming apparatus including the developing device according to the first aspect.

### BRIEF DESCRIPTION OF THE DRAWINGS

FIG. 1 is a schematic sectional view illustrating the internal structure of an image forming apparatus according to a first embodiment of the present disclosure;

FIG. 2 is an external perspective view of a developing unit shown in FIG. 1;

FIG. 3 is a schematic sectional view of the developing unit as seen in the left-right direction;

FIG. 4 is a schematic sectional view of the developing unit as seen in the axial direction of the developing roller;

FIG. 5 is a schematic sectional view of the developing unit in a state in which a cleaner unit is detached;

FIG. 6 is a schematic sectional view of the developing unit in a state in which the cleaner unit and a charging unit are detached;

FIG. 7 is a schematic sectional view of the developing unit in a state which the charging unit is detached; and

FIG. 8 is a schematic sectional view of a developing unit according to a second embodiment.

### DESCRIPTION OF THE EMBODIMENTS

### First Embodiment

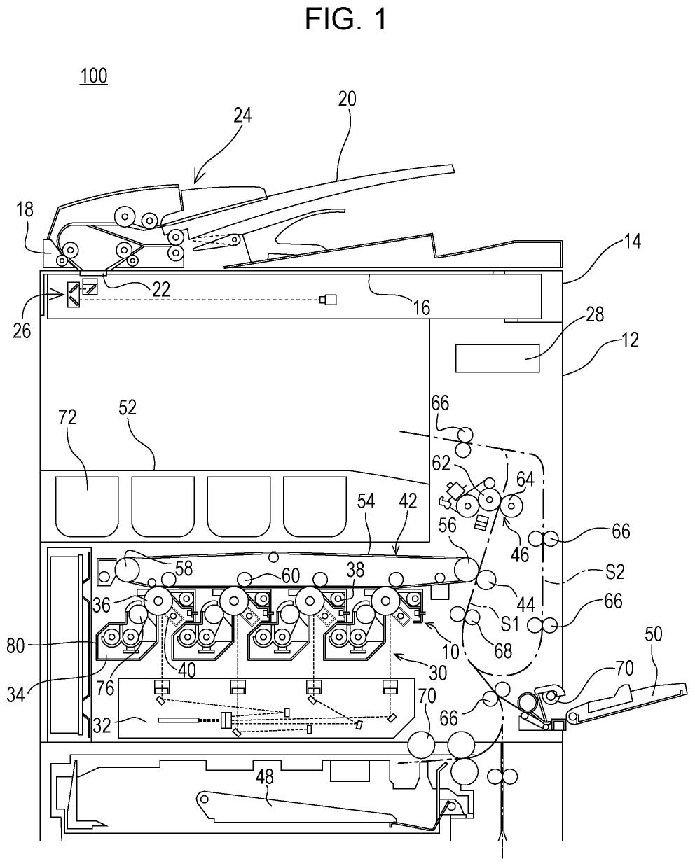

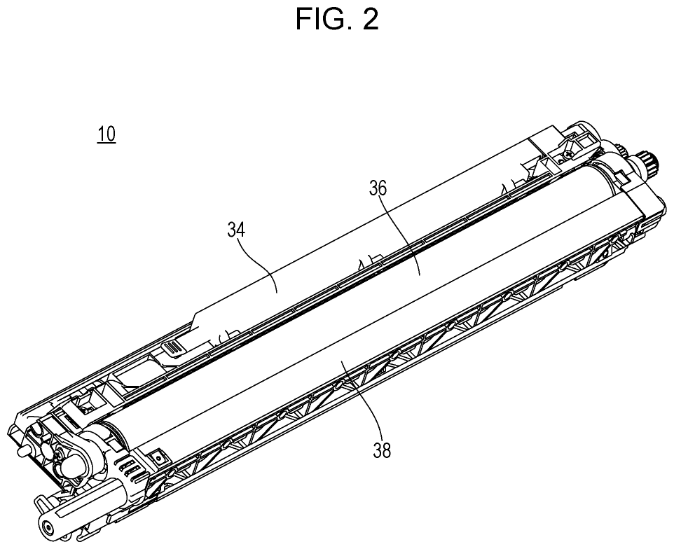

FIG. 1 is a schematic sectional view illustrating the internal structure of a multifunctional peripheral 100 that includes developing units 10 each according to a first embodiment of the present disclosure. FIG. 2 is an external perspective view of one of the developing units 10 shown in FIG. 1.

Referring to FIG. 1, each of the developing units (developing devices) 10 according to the first embodiment of the present disclosure is attachable to and detachable from an image forming apparatus, such as a copier, a facsimile, a printer, or a multifunctional peripheral having the functions of these. In the first embodiment, the developing unit 10 is used for the multifunctional peripheral (MFP) 100 having a copier function, a printer function, a scanner function, a facsimile function, and the like.

In the present specification, among horizontal directions when the multifunctional peripheral 100 is seen from the front, a direction toward the left is defined as the leftward direction, and a direction toward the right is defined as the rightward direction. Among depth directions when the multifunctional peripheral 100 is seen from above (below), a direction toward the front of the multifunctional peripheral 100 is defined as the forward direction (front direction), and a direction toward the back of the multifunctional peripheral 100 is defined as the backward direction (back direction).

First, the structure of the multifunctional peripheral 100 will be schematically described. As illustrated in FIG. 1, the multifunctional peripheral 100 includes a multifunctional peripheral body 12 and an image scanner 14 disposed above the multifunctional peripheral body 12.

The image scanner 14 includes a document table 16 made of a transparent material. A document pressing cover 18 is attached to an upper part of the document table 16 via a hinge or the like so as to be openable and closeable. The document pressing cover 18 includes an automatic document feeder (ADF) 24 that automatically feeds documents placed on a document tray 20 one by one to an image scanning position 22. In front of the document table 16, an operation unit, which includes a touch panel, operation buttons, and the like and which accepts input from a user, is disposed.

The image scanner 14 includes an image scanning unit 26, which includes a light source, a plurality of mirrors, an imaging lens, a line sensor, and the like. The image scanning unit 26 exposes a document surface to light emitted from the light source and guides light reflected from the document surface to the imaging lens via the plurality of mirrors. The imaging lens focuses the reflected light on a light receiving element of the line sensor. The line sensor detects the brilliance or the chromaticity of the reflected light focused on the light receiving element and generates image data based on an image on the document surface. As the line sensor, a charge coupled device (CCD), a contact image sensor (CIS), or the like is used.

The multifunctional peripheral body 12 includes a controller 28 and an image forming section 30. The controller 28 includes a CPU, a memory, and the like. In response to input to the operation unit such as a touch panel, the controller 28 sends control signals to parts of the multifunctional peripheral 100 to cause the multifunctional peripheral 100 to perform various operations.

The image forming section 30 includes exposure units 32, developing mechanisms 34, photoconductor drums 36, cleaner units 38, charging units 40, an intermediate transfer belt unit 42, a transfer roller (second-transfer roller) 44, a fixing unit 46, and the like. The image forming section 30 forms an image on a sheet (recording sheet) that is transported from a sheet feed cassette 48 or a manual-insertion sheet feed cassette 50 and outputs the sheet, on which the image has been formed, to a sheet output tray 52. As image data (print image data) for forming an image on a sheet, image data generated by the image scanning unit 26, image data sent from an external computer, or the like is used.

As illustrated in FIGS. 1 and 2, the developing mechanisms 34, the photoconductor drums 36, the cleaner units 38, and the charging units 40 are integrated into units (cartridges), and each of these units is the developing unit 10.

Print image data used in the multifunctional peripheral 100 corresponds to a color image in four colors that are black (K), cyan (C), magenta (M), and yellow (Y). Therefore, the multifunctional peripheral 100 has four developing mechanisms 34, four photoconductor drums 36, four cleaner units 38, and four charging units 40 that form four latent images corresponding to the four colors and that respectively constitute four image stations. That is, the image forming section 30 includes four developing units 10. In each of the developing units 10, the charging unit 40, the developing mechanism 34, and the cleaner unit 38 are disposed in this order in the rotation direction of the photoconductor drum 36 (clockwise in FIG. 1). Specific structures of components included in the developing unit 10 and the exposure unit 32 will be described below.

Referring back to FIG. 1, the intermediate transfer belt unit 42 includes an intermediate transfer belt 54, a drive roller 56, a driven roller 58, four intermediate transfer rollers 60, and the like. The intermediate transfer belt unit 42 is disposed above the photoconductor drums 36. The intermediate transfer belt 54 is disposed so as to be in contact with each of the photoconductor drums 36. A multicolor toner image is formed on the intermediate transfer belt 54 by successively transferring color toner images, which have been formed on the photoconductor drums 36, to the intermediate transfer belt 54 so as to overlap each other by using the intermediate transfer rollers 60. A transfer roller 44 is disposed close to the drive roller 56. As a sheet passes through a nip region (transfer nip) between the intermediate transfer belt 54 and the transfer roller 44, the toner image formed on the intermediate transfer belt 54 is transferred to the sheet.

The fixing unit 46 includes a heating roller 62 and a pressing roller 64 and is disposed above the transfer roller 44. The heating roller 62 is set so as to have a predetermined fixing temperature. As a sheet passes through a nip region (fixing nip) between the heating roller 62 and the pressing roller 64, the toner image transferred to the sheet is fused, mixed, and pressed, and the toner image is thermally fixed to the sheet.

A first sheet transport path S1 is formed in the multifunctional peripheral body 12. The first sheet transport path S1 is used to feed sheets, which are placed on the sheet feed cassette 48 or the manual-insertion sheet feed cassette 50, via the transfer roller 44 and the fixing unit 46 to the sheet output tray 52. A second sheet transport path S2 is formed in the multifunctional peripheral body 12. The second sheet transport path S2 is used, when performing duplex printing on a sheet, to return a sheet, on which simplex printing has been performed and which has passed through the fixing unit 46, to a position in the first sheet transport path S1 upstream of the transfer roller 44 in the sheet transport direction. In the first sheet transport path S1 and the second sheet transport path S2, registration rollers 68 are disposed, and a plurality of transport rollers 66 for supplying the sheet with an auxiliary driving force are disposed as appropriate.

When the multifunctional peripheral body 12 performs simplex printing, one of the sheets placed on the sheet feed cassette 48 or the manual-insertion sheet feed cassette 50 is guided by a pickup roller 70 to the first sheet transport path S1 and is transported by the transport rollers 66 to the registration rollers 68. Then, the registration rollers 68 transport the sheet to the transfer roller 44 at a timing such that a leading end of the sheet and a leading end of a toner image on the intermediate transfer belt 54 are aligned, and the toner image is transferred onto the sheet. Subsequently, unfixed toner on the sheet is fused with heat and fixed to the sheet as the sheet passes through the fixing unit 46. Then, the sheet passes through the transport rollers (sheet-output rollers) 66 and is output to the sheet output tray 52.

In performing duplex printing, when a trailing end of a sheet, on which simplex printing has been performed and which has passed through the fixing unit 46, reaches the sheet-output rollers 66 near the sheet output tray 52, the sheet-output rollers 66 are reversely rotated, and accordingly the sheet is transported backward and guided to the second sheet transport path S2. The sheet guided to the second sheet transport path S2 is transported by the transport rollers 66 along the second sheet transport path S2. Then, the sheet is guided to a position in the first sheet transport path S1 upstream of the registration rollers 68 in the sheet transport direction. Because the sheet is turned upside down at this time, as the sheet subsequently passes through the transfer roller 44 and the fixing unit 46, printing is performed on the back side of the sheet.

The multifunctional peripheral 100 may have a manual-insertion sheet feed tray, or an external sheet feed unit may be attached to the multifunctional peripheral 100. In such a case, a sheet may be fed to the first sheet transport path L1 from, instead of the sheet feed cassette 48, the manual-insertion sheet feed tray or the sheet feed unit.

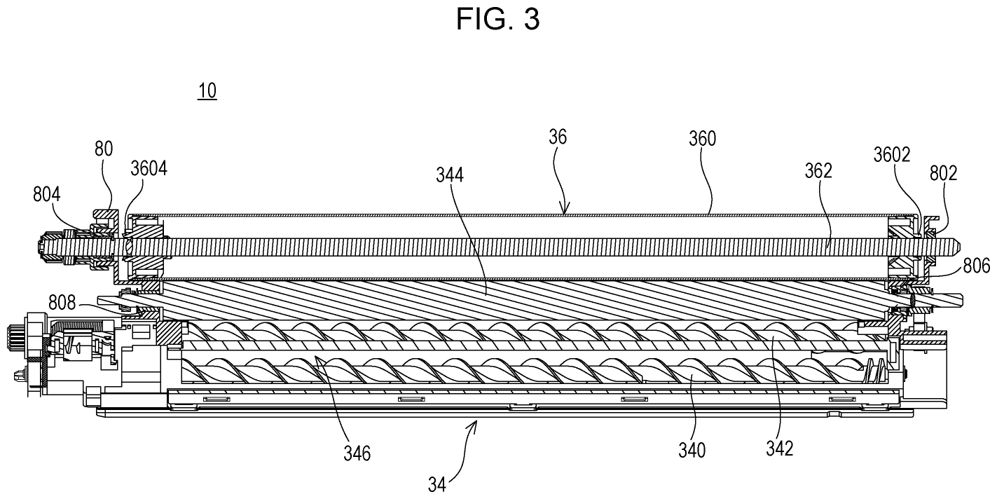

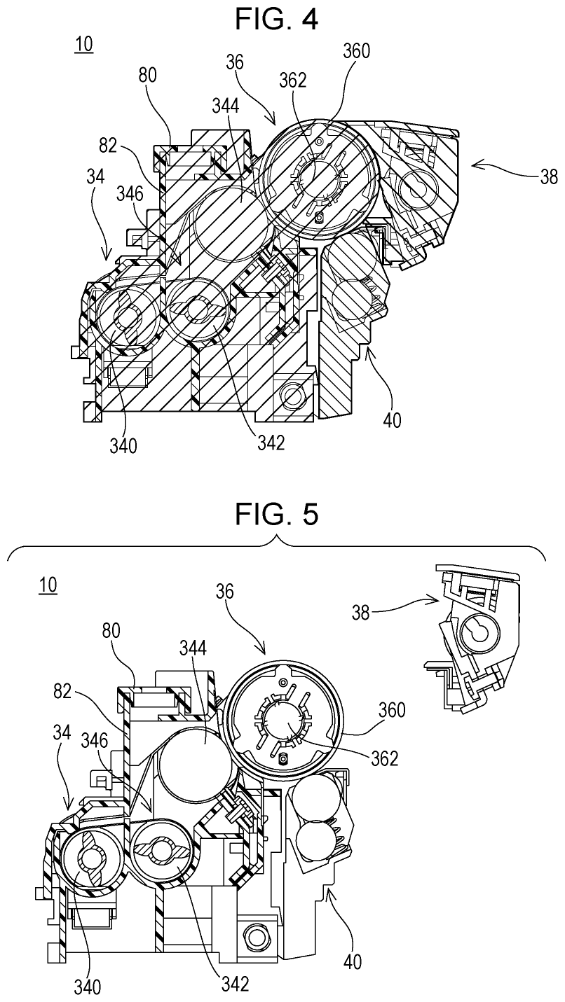

Next, referring to the drawings, specifics of the structure of the developing unit 10 and the exposure unit 32 will be described. FIG. 3 is a schematic sectional view of the developing unit 10 as seen in the left-right direction. FIG. 4 is a schematic sectional view of the developing unit 10 as seen in the axial direction of a developing roller 344.

As illustrated in FIG. 1, the exposure unit 32 is a laser scanning unit (LSU) including a laser emitter, reflection mirrors, and the like. The exposure unit 32 exposes the surface of the photoconductor drum 36 of each image station (the developing unit 10) to light to form a latent image, which corresponds to print image data, on the surface of the photoconductor drum 36.

As illustrated in FIGS. 1 to 4, the developing unit 10 includes a development housing (support member) 80 and a housing cover 82 attached to the development housing 80. The development housing 80 accommodates or supports the components of the developing unit 10 (the developing mechanism 34, the photoconductor drum 36, the cleaner unit 38, and the charging unit 40).

As illustrated in FIGS. 3 and 4, the photoconductor drum 36, which includes a base body 360 and a drum shaft 362, is a latent image carrier in which a photoconductor layer is formed on the surface of the base body 360 having electroconductivity. The photoconductor layer is made of a material that exhibits electroconductivity by being irradiated with light (such as amorphous silicon (a-Si), selenium (Se), or an organic photoconductor (OPC)). The base body 360 is shaped like a cylinder, and flange members 3602 and 3604 are attached to two open end portions of the cylinder (both end portions in the axial direction). The flange members 3602 and 3604 have cylindrical shapes that are coaxial with the base body 360. The drum shaft 362 is inserted into the base body 360 and functions as a shaft member of the photoconductor drum 36. To be specific, the drum shaft 362 is a cylindrical (round-bar-shaped) metal shaft that extends through the inside of the base body 360, the flange members 3602 and 3604, and shaft support portions (bearings) 802 and 804 (each corresponding to a latent-image-carrier holding portion) of the development housing 80. The base body 360 (the flange members 3602 and 3604) and the drum shaft 362 are fixed to each other by using a parallel pin or the like. Both end portions of the drum shaft 362 are covered by holders disposed on the development housing 80. Moreover, the drum shaft 362 is rotatably supported by the development housing 80 via the shaft support portions 802 and 804. That is, the photoconductor drum 36 is rotatably supported by the development housing 80 via the drum shaft 362 and the shaft support portions 802 and 804. The drum shaft 362 can be inserted into and extracted from the base body 360 and the shaft support portions 802 and 804. That is, the base body 360 is supported by the development housing 80 so as to be attachable to and detachable from the development housing 80. The drum shaft 362 is rotated by a rotational driving source (not shown) such as a motor.

The charging unit 40 charges the surface of the photoconductor drum 36 to a predetermined electric potential. As the charging unit 40, a corona charger, a brush charger, a roller charger, an ion generator, or the like may be used. The charging unit 40 is supported by the development housing 80 so as to be attachable to and detachable from the development housing 80. To be specific, the charging unit 40 is attached to the development housing 80 by using a fastening member such as a screw.

The developing mechanism 34 develops a latent image formed on the surface of the photoconductor drum 36 into a visible image (toner image) by using a toner in a corresponding one of the four colors (YMCK). To the developing mechanism 34, a toner replenishing member (toner cartridge) 72 (see FIG. 1) is connected via a toner supply pipe (not shown). The toner cartridge 72 is a container that stores a developer (two-component developer) that is composed of an unused toner and a carrier. The toner cartridge 72 is disposed above the developing mechanism 34 (the image forming section 30), supplies (replenishes) the toner to the developing mechanism 34, and replenishes the carrier. The toner supply pipe couples (connects) the inside the toner cartridge 72 to a toner replenishing port of the developing mechanism 34. The developer is not limited to a two-component developer, and a one-component developer may be used. In this case, the toner cartridge 72 stores only toner to be used, and the toner cartridge 72 supplies the toner to the developing mechanism 34 as necessary.

The developing mechanism 34 includes a first transport member 340, a second transport member 342, and the developing roller (magnet roller) 344.

A developer tank 346 is formed in the development housing 80 and has an elongated substantially-box-like shape extending in the front-back direction. The developer tank 346 contains (stores) a developer, and a toner included in the developer is supplied to the photoconductor drum 36 via the developing roller 344. Illustration of the toner, the carrier, and the developer, in which the toner and the carrier are mixed, is omitted.

The first transport member 340, the second transport member 342, and the developing roller 344 are disposed inside the developer tank 346. That is, the first transport member 340, the second transport member 342, and the developing roller 344 are accommodated in the developer tank 346.

The first transport member 340 and the second transport member 342 are, for example, transport screws and circulate the developer in a predetermined direction in the development housing 80 (in the developer tank 346) while agitating the toner and the carrier. Moreover, the second transport member 342 transports the toner and the carrier in the developer tank 346 toward the developing roller 344 while agitating the toner and the carrier. The first transport member 340 and the second transport member 342 are rotated by a rotational driving source (not shown) such as a motor. The toner contained in the developer tank 346 is charged by causing friction with the carrier while being agitated by the first transport member 340 and the second transport member 342.

The developing roller 344, which is a magnet roller that functions as a developer carrier, is disposed at a position facing the photoconductor drum 36 so as to be substantially parallel to the photoconductor drum 36. The developing roller 344 has a substantially cylindrical shape, and both end portions of the developing roller 344 extend through shaft support portions 806 and 808 of the development housing 80. The developing roller 344 is rotatably supported by the development housing 80 via the shaft support portions (bearings) 806 and 808 (each corresponding to a developer-carrier holding portion). In the present embodiment, the shaft support portions 806 and 808 are disposed closer to the center of the developing roller 344 in the axial direction than the shaft support portions 802 and 804, which support the photoconductor drum 36. The developing roller 344 is rotated by a rotational driving source (not shown) such as a motor. The developing roller 344 carries the developer in the developer tank 346, which has been transported by the second transport member 342, on the surface thereof and supplies the toner included in the developer to the surface of the photoconductor drum 36. Thus, a latent image formed on the surface of the photoconductor drum 36 is developed (into a visible image).

A part of the top wall of the development housing 80 (a part of the top wall of the development housing 80 above the first transport member 340 in the vertical direction) has an open end, and an opening is formed at the open end. The housing cover 82, which covers the opening, is supported by the development housing 80 so as to be attachable to and detachable from the development housing 80, for example, by being fastened or engaged. When the housing cover 82 is attached to the development housing 80, the developer tank 346 becomes tightly closed. When the housing cover 82 is detached from the development housing 80, the developer tank 346 becomes open.

The cleaner unit 38 includes a cleaning blade that contacts the surface of the photoconductor drum 36, a transport screw, and the like. The cleaning blade is a plate-shaped member for scraping off toner that remains on the surface of the photoconductor drum 36. The transport screw transports the toner scraped off by the cleaning blade to a recovery container such as a waste toner box (not shown). The cleaning blade is disposed in such a way that the longitudinal direction thereof coincides with the direction of the rotation axis of the photoconductor drum 36. The cleaner unit 38 is supported by the development housing 80 so as to be attachable to and detachable from the development housing 80. To be specific, the cleaner unit 38 is attached to the development housing 80 via a fastening member such as a screw.

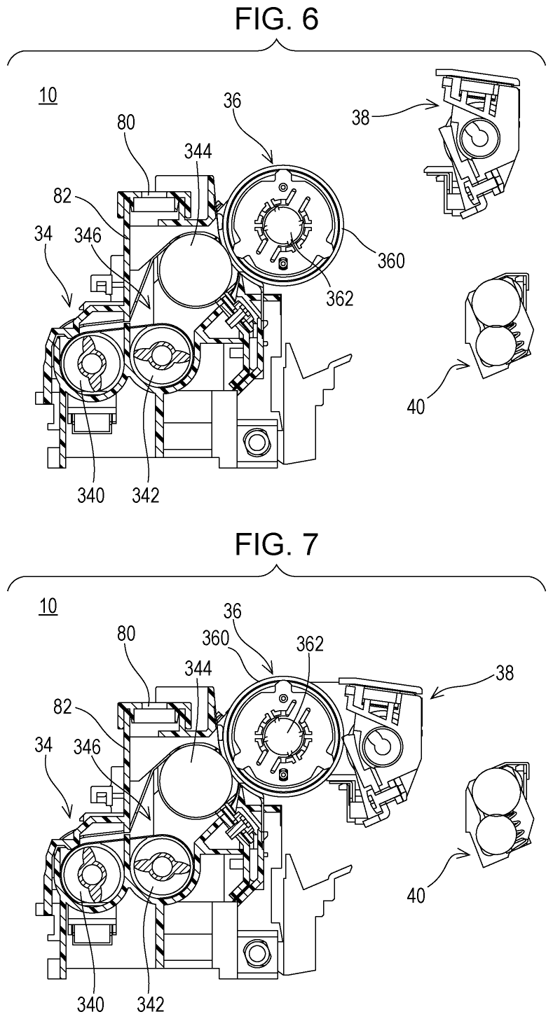

FIG. 5 is a schematic sectional view of the developing unit 10 in a state in which the cleaner unit 38 is detached. FIG. 6 is a schematic sectional view of the developing unit 10 in a state in which the cleaner unit 38 and the charging unit 40 are detached. FIG. 7 is a schematic sectional view of the developing unit 10 in a state in which the charging unit 40 is detached.

As described above, the photoconductor drum 36, the cleaner unit 38, the charging unit 40, and the housing cover 82 are each independently attachable to and detachable from the development housing 80. In the development housing 80, a cleaner-unit positioning portion (not shown) and a charging-unit positioning portion (not shown) are formed. The cleaner unit 38 is attached to the development housing 80 so as to be aligned with the cleaner-unit positioning portion. Thus, the cleaner unit 38 is positioned relative to the photoconductor drum 36. The charging unit 40 is attached to the development housing 80 so as to be aligned with the charging-unit positioning portion. Thus, the charging unit 40 is positioned relative to the photoconductor drum 36. It is not necessary that the distance between the photoconductor drum 36 and the cleaner unit 38 and the distance between the photoconductor drum 36 and the charging unit 40 be as accurate as the distance (DSD) between the photoconductor drum 36 and the developing roller 344. Accordingly, the cleaner unit 38 and the charging unit 40 can operate with sufficient performance even with the attachment structures described above.

As illustrated in FIG. 5, when the cleaner unit 38 is detached the development housing 80, a space above the photoconductor drum 36 becomes open. Accordingly, by extracting the drum shaft 362 from the base body 360 in the state in which the cleaner unit 38 is detached from the development housing 80, it is possible to detach the photoconductor drum 36 (the base body 360) from the development housing 80 and to attach the photoconductor drum 36 to the development housing 80.

As illustrated in FIG. 6, the cleaner unit 38 and the charging unit 40 each can be detached from the development housing 80. As illustrated in FIG. 7, the charging unit 40 can be independently detached from the development housing 80.

In the first embodiment, the photoconductor drum 36 and the developing roller 344 are attached to the development housing 80. That is, the photoconductor drum 36 and the developing roller 344 are attached to the same member. Therefore, the accuracy of the distance (DSD) between the photoconductor drum 36 and the developing roller 344 can be increased. In particular, by forming a portion that supports the photoconductor drum 36 and a portion that supports the developing roller 344 by using the same slide core when manufacturing the development housing 80, it is possible to realize an accuracy of about ±0.015 mm for the center-to-center distance between the photoconductor drum 36 and the developing roller 344. Accordingly, it is not necessary to provide a pressing mechanism for ensuring the accuracy of DSD, and it is not necessary to perform an adjustment operation when assembling the developing unit 10.

With the first embodiment, because the photoconductor drum 36 is independently attachable to and detachable from the development housing 80, it is easy to perform replacement of the photoconductor drum 36.

Moreover, with the first embodiment, because the cleaner unit 38 is independently attachable to and detachable from the development housing 80, it is easy to perform replacement or maintenance of the cleaner unit 38. Furthermore, with the first embodiment, because the charging unit 40 is independently attachable to and detachable from the development housing 80, it is easy to perform replacement or maintenance of the charging unit 40. As described above, with the first embodiment, because the cleaner unit 38 and the charging unit 40 are each independently attachable to and detachable from the development housing 80, it is possible to attach each of the cleaner unit 38 and the charging unit 40 to the development housing 80 with an optimal timing. Accordingly, the photoconductor drum 36, the cleaner unit 38, and the charging unit 40 can be used in good conditions. For example, it is possible to reduce the time during which the cleaning blade continues to be in contact with the same part of the photoconductor drum 36.

Moreover, with the first embodiment, when the housing cover 82 is detached from the development housing 80, the developer tank 346 becomes open and it is possible to replace the developer. Because it is not necessary to detach the photoconductor drum 36, the cleaner unit 38, and the charging unit 40 at this time, it is easy to perform the operation of replacing the developer.

### Second Embodiment

A multifunctional peripheral 100 according to the second embodiment is the same as the multifunctional peripheral 100 according to the first embodiment except that the base body 360 of the photoconductor drum 36 can be temporarily placed on the development housing 80. Therefore, differences from the first embodiment will be described, and redundant description will be omitted.

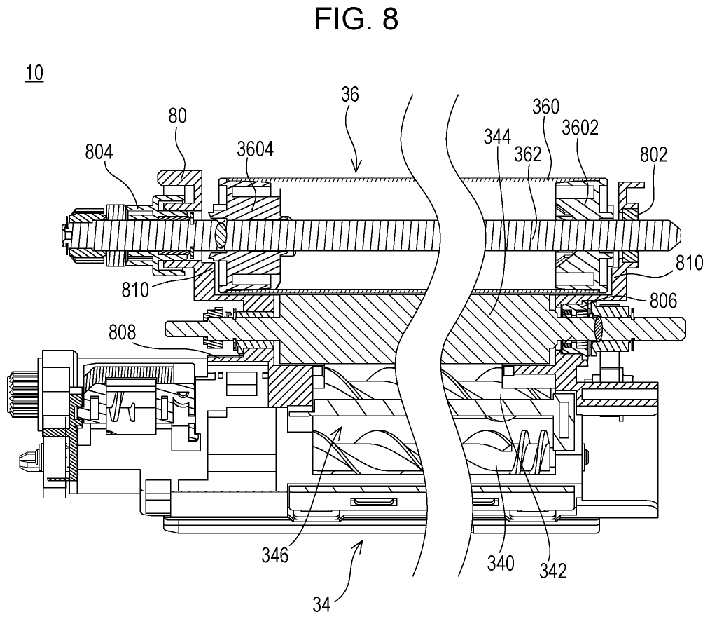

FIG. 8 is a schematic sectional view of a developing unit 10 according to a second embodiment. As illustrated in FIG. 8, a development housing 80 according to the second embodiment includes temporary holding portions 810 that hold the base body 360 by supporting both end portions of the photoconductor drum 36 (the base body 360) in the axial direction.

For example, the temporary holding portions 810 are protrusions that protrude from walls in which the shaft support portions 802 and 804 are formed (walls that are perpendicular to the axial direction of the drum shaft 362) toward the center in the axial direction of the drum shaft 362 (the axial direction of the base body 360). The positions of the upper ends of the temporary holding portions 810 are set so that, when the base body 360 is placed on the temporary holding portions 810, the base body 360 is located slightly below the position of the base body 360 when the drum shaft 362 is inserted into the base body 360 (the position when the base body 360 is attached to the development housing 80). Accordingly, when the base body 360 is attached to the development housing 80, gaps are formed between the base body 360 and the temporary holding portions 810, and the base body 360 does not contact the temporary holding portions 810.

With the second embodiment, before the drum shaft 362 is inserted into the base body 360 of the photoconductor drum 36, that is, before the base body 360 is attached to the development housing 80, the base body 360 can be temporarily placed (held) on the temporary holding portions 810, and it is possible to attach (insert) the drum shaft 362 in the state in which the base body 360 is held. Therefore, it is easy to perform assembly and replacement of the base body 360.

In each of the embodiments described above, the image forming apparatus is a multifunctional peripheral. However, an image forming apparatus according to the present disclosure may be a printer, a copier, or a facsimile.

In each of the embodiments described above, the multifunctional peripheral 100 is a color multifunctional peripheral. However, an image forming apparatus according to the present disclosure may be a monochrome printer or a monochrome multifunctional peripheral.

Moreover, in each of the embodiments described above, the shaft support portions 806 and 808 of the development housing 80 are disposed closer to the center of the developing roller 344 in the axial direction than the shaft support portions 802 and 804 that support the photoconductor drum 36. However, the positional relationship between the shaft support portions is not limited to this. The positional relationship between the shaft support portions 802 and 804 and the shaft support portions 806 and 808 in the axial direction of the developing roller 344 (the photoconductor drum 36) may be changed as appropriate. For example, by extending the end portions of the developing roller 344, it is possible to make the positions of the shaft support portions 802 and 804 be substantially the same as the positions of the shaft support portions 806 and 808 in the axial direction of the developing roller 344. By doing so, it is possible to reduce displacement between the photoconductor drum 36 and the developing roller 344 in the longitudinal direction and to further improve the accuracy of DSD.

Specific shapes and the like that are shown in each of the embodiments described above are examples and may be changed as appropriate in accordance with the actual product.

The present disclosure contains subject matter related to that disclosed in Japanese Priority Patent Application JP 2018-093715 filed in the Japan Patent Office on May 15, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A developing device comprising:
a housing that forms a developer tank that contains a developer;
a latent image carrier that has a surface on which a latent image is to be formed;
a developer carrier that is accommodated in the developer tank and that carries the developer that is used to develop the latent image formed on the latent image carrier;
a latent-image-carrier holding portion that is disposed in the housing and that holds the latent image carrier at a predetermined position; and
a developer-carrier holding portion that is disposed in the housing and that holds the developer carrier at a predetermined position.

2. The developing device according to claim 1,
wherein the latent-image-carrier holding portion attachably and detachably holds the latent image carrier.

3. The developing device according to claim 1,
wherein the latent image carrier includes a base body having a tubular shape, and
wherein the latent-image-carrier holding portion includes a temporary holding portion that holds the base body by supporting both end portions of the base body in an axial direction.

4. An image forming apparatus comprising:
the developing device according to claim 1.

5. The image forming apparatus according to claim 4, further comprising:
a cleaner unit that removes the developer that remains on the surface of the latent image carrier,
wherein the developing device further includes a cleaner-unit holding portion that is disposed in the housing and that holds the cleaner unit at a predetermined position.

6. The image forming apparatus according to claim 4, further comprising:
a charging unit that charges the surface of the latent image carrier,
wherein the developing device further includes a charging-unit holding portion that is disposed in the housing and that holds the charging unit at a predetermined position.
